(19) United States
(12) Patent Application Publication
(10) Pub. No.: US 2017/0197354 A1
(43) Pub. Date: Jul. 13, 2017

(54) METHOD FOR MANUFACTURING THERMOPLASTIC SYNTHETIC RESIN EMBLEM WITH INDIVIDUAL INFORMATION DATE

(71) Applicants: Nobuo KURODA, Osaka-shi, Osaka (JP); Eiji KUWAHARA, Osaka-shi, Osaka (JP)

(72) Inventor: Eiji KUWAHARA, Osaka-shi (JP)

(73) Assignees: Nobuo KURODA, Osaka-shi, Osaka (JP); Eiji KUWAHARA, Osaka-shi, Osaka (JP)

(21) Appl. No.: 15/326,988

(22) PCT Filed: Jul. 17, 2014
(86) PCT No.: PCT/JP2014/069053

§ 371 Date: Feb. 22, 2017

(51) Int. Cl. B29C 59/02; B44C 5/00; B32B 37/06; B41M 5/24; B32B 38/06; B32B 38/00; B32B 27/06; B41F 15/00; B44C 1/22; B32B 37/10

(52) U.S. Cl. CPC B29C 59/026; B44C 1/228; B44C 5/00; B32B 37/06; B32B 37/10; B32B 38/06; B32B 38/145; B32B 38/0008; B32B 27/06; B41F 15/00; B41M 5/24; B32B 2255/205; B32B 2255/10; B29K 2905/00

(57) ABSTRACT

A method for manufacturing emblems that can be mass-produced while being able to identify individual people, characterized in being configured so that the upper surface of an intermediate layer material is made visible by: placing the intermediate layer material on a lower layer material and a thermoplastic synthetic resin film upper layer material on said intermediate layer material, pressing the upper layer material, intermediate layer material and lower material with an engraving die that has a thermal cutting blade that follows the emblem countour line and performing induction heating by transmitting a high frequency to form a design on the upper layer material, removing unneccesary sections and creating an intermediate decorative piece, fitting said intermediate decorative piece in a jig and setting same in a laser engraver, and perfoming laser engraving using said individual information data and removing portions of the upper layer material according to the individual information data.

### TECHNICAL FIELD

This invention relates to an emblem to be attached to a military uniform, a police uniform, a fire fighter uniform or an official uniform of any other public office or a private company. More particularly, the present invention relates to an emblem having an information part that can identify an individual person.

### BACKGROUND ART

Patent literatures that disclose a method for manufacturing a decorative piece such as an emblem, an applique or a sticker by high frequency induction heating, using thermoplastic synthetic resin film as starting material and a decorative piece manufactured by the method include among others Patent Literatures 1, 2, 3 and 4 listed hereinafter.

For instance, a decorative piece as disclosed in Patent Literature 1 includes a lower layer (formed by using vinyl chloride film 11) and an upper layer made of thermoplastic synthetic resin (a polyester sheet 1). A sheet of thermoplastic synthetic resin film may be used as the material of the upper layer. The lower layer may be made of any appropriate material such as woven fabric, knitted fabric, synthetic resin (vinyl chloride 11 in Patent Literature 1) or synthetic leather. When a decorative piece is to be provided as a thermally transferable one, thermal bonding film can be used for the lower layer of the decorative piece.

As described above, a decorative piece having an upper layer that is made of thermoplastic synthetic resin and a lower layer can be manufactured by means of high frequency induction heating.

When manufacturing a decorative piece by means of high frequency induction heating, a metal mold table that operates as one of the electrodes for high frequency induction heating (which corresponds to the lower electrode 16′ in Patent Literature 1) and a carving metal mold that operates as the other electrode for high frequency induction heating (which corresponds to the upper electrode 16 in Patent Literature 1) are employed.

A carving metal mold as described above has a fusion cutting blade (which corresponds to the blade section 17 in Patent Document 1) and a pressing blade (which corresponds to the protruding section 14′ in Patent Literature 1). The fusion cutting blade has a sharp edge running along the outer contour line of the pattern to be produced and is employed to cut the thermoplastic synthetic resin film that is the material of the patterned piece to be manufactured by fusion cutting. On the other hand, the edge of the pressing blade is placed in a plane located above the horizontal plane where the sharp edge is found and not as sharp as the above described sharp edge of the fusion cutting blade. The pressing blade is designed to produce a given three-dimensional pattern out of the thermoplastic synthetic resin film.

For manufacturing an emblem, if necessary, firstly a pattern is printed on a sheet of thermoplastic synthetic resin film, which is the material of the upper layer. Then, the lower film material is laid on the metal mold table and subsequently a sheet of thermoplastic synthetic resin film, which is the material of the upper layer, is laid thereon. Thereafter, the thermoplastic synthetic resin film and the lower layer material are pressed down from above by means of the carving metal mold and a high frequency induction heating operation is executed on them. As a result, a three-dimensional pattern is formed on the thermoplastic synthetic resin film due to the carving shape of the carving metal mold and by the pressure applied by the pressing blade. Additionally, the thermoplastic synthetic resin film is fused and cut by the fusion cutting blade to define the outer contour line of the patterned piece. Furthermore, as a result of the high frequency induction heating operation, the thermoplastic synthetic resin film is molten to consequently unify the upper layer and the lower layer to produce a decorative piece. Then, all the unnecessary parts are removed to complete the operation of producing a finished decorative piece. When the decorative piece to be manufactured is a thermal bonding film type one (in which the lower layer is made of a material having a property like that of thermal adhesives and can thermally be bonded to a jacket or some other outer wear to which it is to be bonded by ironing), a sheet of release paper may be arranged on the lower surface of the formed lower layer or a sheet of transparent carrier film may be arranged on the top surface of the patterned piece. When the lower layer material is fabric or the like, some other known means may be used to cut it instead of fusion cutting by means of high frequency induction heating.

### PRIOR ART LITERATURES

### Patent Literatures

[Patent Literature 1]: JP-B No. Sho 61-016608
[Patent Literature 2]: JP-B-No. Hei 06-033040

### [Patent Literature 3]: JP-B-Patent No. 2542551

### [Patent Literature 4]: JP-A-Japanese Patent Laid-Open No. 2008-30199

### DISCLOSURE OF THE INVENTION

### Problem to be Solved by the Invention

Thus, with the above described prior art, decorative pieces such as emblems made of thermoplastic synthetic resin can be manufactured on a mass production basis.

Additionally, soft and lightweight emblems can be manufactured by using soft resin film. Thus, if such an emblem is attached to the breast pocket of a shirt or a uniform jacket, it would not hang down from the pocket due to its weight and, if such an emblem is attached to one of the sleeves of a shirt or a uniform jacket, it can accommodate any move of the arm and would not give any uncomfortable feeling to the wearer of the shirt or the jacket, whichever appropriate, because of its softness and flexibility.

However, when emblems are manufactured on a mass production basis, all the emblems manufactured in lots show a same shape, a same pattern and same colors and hence they cannot be used to identify the individuals wearing them. In recent years, there has been a demand for emblems and other decorative pieces that can be used to identify individuals who are bearing them.

Thus, the object of the present invention is to provide a method for manufacturing emblems that can be manufactured on a mass production basis and can identify the individual persons bearing them.

### Means for Solving the Problem

According to the present invention, there is provided a method for manufacturing an emblem made of thermoplastic synthetic resin and having data on information of an individual bearer of the emblem, the method being characterized by comprising:

(a) placing a lower layer material on a table operating as one of a pair of electrodes for high frequency induction heating, placing an intermediate layer material of a sheet of thermoplastic synthetic resin film on the lower layer material and placing an upper layer material of thermoplastic synthetic resin film on the intermediate layer material;

(b) pressing the upper layer material, the intermediate layer material and the lower layer material by means of a carving metal mold operating as the other electrode for high frequency induction heating, the carving metal mold having a fusion cutting blade running along the contour line of the emblem and transmitting a high frequency wave to execute an induction heating operation to carve a pattern on the upper layer material;

(c) preparing an intermediate decorative piece by removing unnecessary parts;

(d) inlaying the intermediate decorative piece in a jig and setting the jig in position in a laser carving machine;

(e) preparing data on information of the individual bearer of the emblem by means of a computer connected to the laser carving machine; and

(f) executing a laser carving operation by means of the data on information of the individual bearer of the emblem, removing the upper layer material of the information part so as to expose the top surface of the intermediate layer material (Claim 1).

Preferably, the intermediate layer material is either sheet of white thermoplastic synthetic resin film that can be colored by screen printing or a sheet of transparent thermoplastic synthetic resin film that can be colored by screen printing (Claim 2).

Preferably, the thermoplastic synthetic resin film of the upper layer material has a vapor deposited metal layer (Claim 3).

Preferably, the intermediate layer material is a sheet of transparent film and the lower layer material is a translucent material (Claim 4).

Preferably, the lower layer material is thermoplastic synthetic resin film, fabric, hot melt film or double sided tape made of thermoplastic synthetic resin film (Claim 5).

Preferably, the thermoplastic synthetic resin film of the upper layer material, the intermediate layer material or the lower layer material is soft and flexible (Claim 6).

### Advantages of the Invention

With the invention defined in Claim 1, thermoplastic synthetic resin emblems can be manufactured on a mass production basis by way of the steps (a) through (c) and individual information can be stored in each of the emblems by way of the steps (d) through (f). Thus, emblems that can identify the individual bearers thereof can be manufactured while maintaining the advantage of mass production.

With the invention defined in Claim 2, emblems whose intermediate layers tinted to show one or more than one desired colors are visible after removing the upper layer parts thereof can be obtained.

With the invention defined in Claim 3, emblems whose surfaces show a metallic luster can be obtained.

With the invention defined in Claim 4, the color or colors of parts of emblems from which the related upper layer parts are removed can be changed by irradiating the emblems with light emitted from light sources such as LEDs (light emitting diodes) from the rear surfaces thereof (the rear surfaces of the lower layers thereof).

With the invention defined in Claim 5, emblems having one or more one desired properties (e.g., a property capable of being bonded to a jacket or the like by means of an iron).

### BRIEF DESCRIPTION OF THE DRAWINGS

FIG. 1 is a schematic front view of an emblem manufactured by a method according to the present invention.

FIG. 2 is a schematic cross sectional view of the emblem of FIG. 1, taken along line II-II in FIG. 1.

FIG. 3 is a schematic bottom view of a carving metal mold that can be used for the purpose of the present invention.

FIG. 4 is a schematic cross sectional view of the carving metal mold of FIG. 3, taken along line iv-iv in FIG. 3.

FIG. 5 is a schematic front view of an intermediate decorative piece.

FIG. 6 is a schematic front view a jig with an intermediate decorative piece inlayed therein.

FIG. 7 is a schematic lateral view of a jig with an intermediate decorative piece inlayed therein.

### BEST MODE FOR CARRYING OUT THE INVENTION

<An Emblem to be Manufactured by a Method According to the Present Invention>

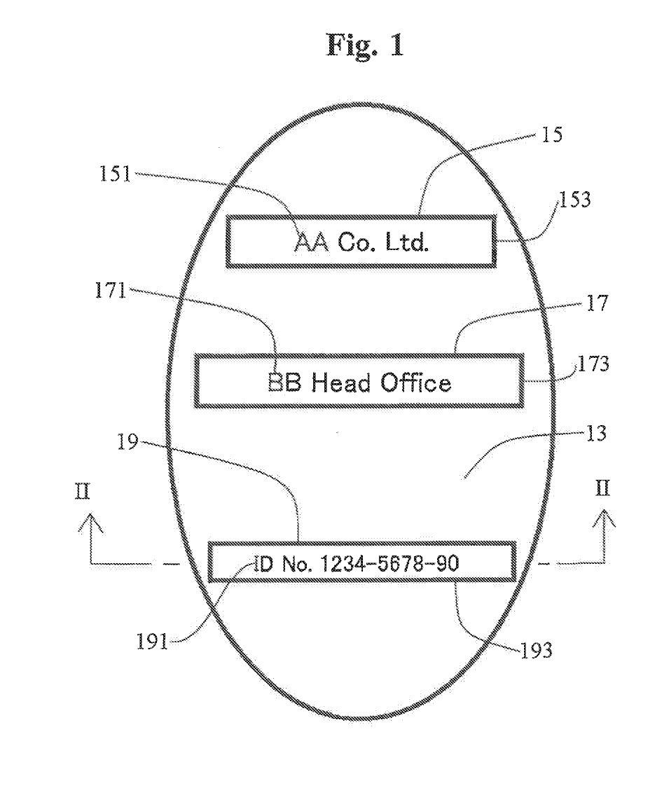

FIG. 1 is a schematic view of an emblem manufactured by a method according to the present invention.

While the emblem shown in FIG. 1 is made to show a simple elliptical contour for the purpose of simplicity of explanation, it may be needless to say that the emblem can be made to show an undulated surface or an even more complex profile. For example, an emblem according to the present invention can be made to show a complex profile and a complex pattern as disclosed in above cited Patent Literature 4.

The emblem shown in FIG. 1 has an elliptical profile as a whole and includes an overall surface 13, a first pattern part 15, a second pattern part 17 and a third pattern part. In other words, the overall surface 13 refers to the part other than the first pattern part 15, the second pattern part 17 and the third pattern part 19.

For the purpose of simplification of explanation, the overall surface 13 of the illustrated embodiment is a flat surface, although it may be needless to say that the overall surface can be made to show undulations.

The first pattern part 15 is arranged in an upper area of the overall surface. Note that characters 151 of “AA Co., Ltd.” are shown in the first pattern part 15 and the characters are surrounded by a transversally oblong rectangle 153.

The second pattern part 17 is arranged in a central area of the overall surface 13. Characters 171 of “BB Head Office” are shown in the second pattern part 17 and the characters 143 surrounded by a transversally oblong rectangle 173.

The third pattern part 19 is arranged in a lower area of the overall surface. Characters 191 of “ID No. 1234-5678-90” are shown in the third pattern part 19 and the characters 191 are surrounded by a transversally oblong rectangle 193.

The first pattern part 15 shows the name of a company, When a plurality of emblems are to be manufactured, a same design can be used for all the first pattern parts 15 of parts 15 can be produced by means of the above described prior art. To the contrary, the second pattern part 17 shows the organizational section where the bearer of each of the manufactured emblems belongs and the third pattern part 19 shows the ID No. assigned to the bearer of the emblem. In other words, the characters 171 of the second pattern part 17 and the characters 191 of the third pattern part 19 constitute “an information part”. The characters 171 of the second pattern part 17 and the characters 191 of the third pattern part 19 need to be formed for each of the emblems and hence cannot be produced on a mass production basis. Differently stated, they cannot be formed by the above described prior art and the present invention is used to produce such “information parts”.

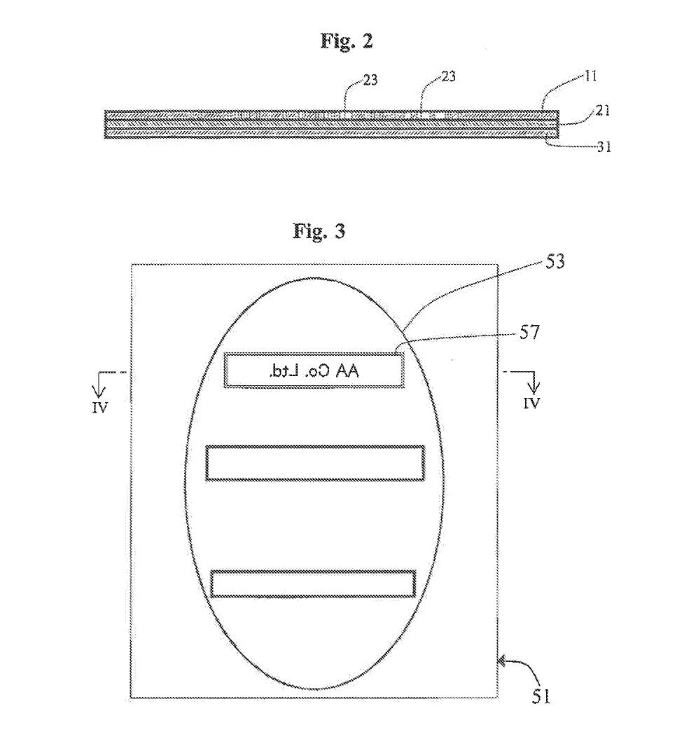

As shown in FIG. 2, an emblem manufactured by a method according to the present invention comprises an upper layer 11, an intermediate layer 21 and a lower layer 31. The upper layer 11 is a layer for making the surface of a three-dimensional decorative piece to appear beautiful. A three-dimensional pattern is carved there and one or more than one colors and patterns are printed there by means of a known printing technique such as screen printing.

The intermediate layer 21 is a layer for causing the three-dimensional decorative piece to show a thickness and at, at the same time, the characters and the signs of the information part to color. The top surface of the intermediate layer 21 is colored by a known printing technique such as screen printing. The surface of the intermediate layer 21 may be monochromatic or multi-colored. Alternatively, a coloring sheet may be used for the top surface.

The lower layer 31 is the base material of the emblem.

<Upper Layer Material>

Any material known in the technical field can e used as the material 11a of the upper layer 11. Thermoplastic synthetic resin film can be used as the material of the upper layer 11. Examples of thermoplastic synthetic resin films that can be used for the upper layer 11 include poly vinyl chloride film, polyurethane film, polyester film and polyolefin film. Preferably, the thermoplastic synthetic resin film to be used for the upper layer 11 is soft and flexible.

Metal may be vapor deposited on the thermoplastic synthetic resin film of the upper layer 11 so as to make it appear like a metal-made three-dimensional decorative piece. For example, metal vapor deposited polyvinyl chloride film, metal vapor deposited polyurethane film, metal vapor deposited polyester film or metal vapor deposited polyolefin film can be used for the thermoplastic synthetic resin film of the upper layer. Examples of metals that can be used for this purpose include aluminum and chromium. Metal may be deposited on one of the opposite surfaces of thermoplastic synthetic resin film or a vapor deposited metal layer may be sandwiched between two thermoplastic synthetic resin film layers. The thermoplastic synthetic resin film may be laminate film.

An appropriate upper layer material may be selected according to the three-dimensional decorative pieces to be manufactured.

The upper layer material is colored by printing in advance, using a known printing means such as screen printing.

<Intermediate Layer Material>

Any material known in this field can be used as the material 21a of the intermediate layer 21. Examples of materials that can be used for the intermediate layer include sheets of polyvinyl chloride film and those of polyurethane film. The intermediate layer material may be foamed thermoplastic synthetic resin. For example, sheets of foamed polyvinyl chloride or those of foamed polyurethane may be used for the intermediate layer. An appropriate intermediate layer material may be selected according to the three-dimensional decorative pieces to be manufactured. The thermoplastic synthetic resin to be used for the intermediate layer is preferably soft and flexible.

The surface (upper surface 23) of the intermediate layer material 21a that is brought into contact with the upper layer 11 is colored by an appropriate known printing means such as screen printing. When the upper surface of the intermediate layer material is monochromatic, a colored sheet of film may be used as the intermediate layer material 21a.

<Lower Layer Material>

Any material known in this field can be used as the material 31a of the lower layer 31. Examples of lower layer material 31a include thermoplastic synthetic resin film, hot melt film and thermoplastic synthetic resin double sided tape, although the present invention is by no means limited to the use of any of such materials. The thermoplastic synthetic resin of the lower layer is preferably soft and flexible. An appropriate lower layer material 31a may be selected according to the emblems to be manufactured. When, for example, emblems to be attached to jackets or the like by heating the emblems by means of irons or the like are to be manufactured, the use of hot melt film may appropriately be selected as the lower layer material.

When sheets of transparent film and a translucent material such as synthetic resin-made transparent double-sided tape are selected respective for the intermediate layer material 21a and the lower layer material 31a, the color or colors of the part of the intermediate layer of the emblem from which the upper layer part is removed (information part) can be changed by irradiating the rear surface (the lower surface of the lower layer) of the emblem with light emitted from an LED (light emitting diode).

<Apparatus to be Used for the Manufacturing Method According to the Present Invention>

As described above, the method for manufacturing an thermoplastic synthetic resin emblem according to the present invention comprises:

(a) placing a lower layer material 31a on a table 41 operating as one of a pair of electrodes for high frequency induction heating, placing an intermediate layer material 21a of a sheet of thermoplastic synthetic resin film on the lower layer material 31a and placing an upper layer material 11a of thermoplastic synthetic resin film on the intermediate layer material 21a;

(b) pressing the upper layer material 11a, the intermediate layer material 21a and the lower layer material 31a by means of a carving metal mold 51 operating as the other electrode for high frequency induction heating, the carving metal mold 51 having a fusion cutting blade running along the contour line of the emblem and transmitting a high frequency wave to execute an induction heating operation to carve a pattern on the upper layer material 11a;

(c) preparing an intermediate decorative piece 61 by removing unnecessary parts;

(d) inlaying the intermediate decorative piece 51 in a jig and setting the jig in position in a laser carving machine;

(e) preparing data on information of the individual bearer of the emblem by means of a computer connected to the laser carving machine; and

(f) executing a laser carving operation by means of the data on information of the individual bearer of the emblem, removing the upper layer material of the information part so as to expose the top surface of the intermediate layer material.

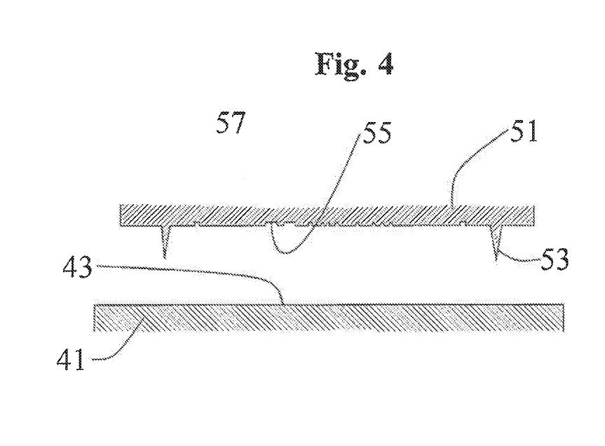

As described earlier, the first pattern part 15 of the illustrated embodiment shows the name of a company and hence can be manufactured on a mass production basis. In other words, a same design is employed for a plurality of emblems to be manufactured. Thus, as shown in FIG. 4, the characters 151 and the transversally oblong rectangle 153 can be formed by high frequency induction heating. More specifically, the characters 151 are formed by using recessed parts 55 of the carving metal mold 51 and the rectangle 51 is formed by using recessed part 57 of the carving metal mold 51.

As shown in FIG. 4, the carving metal mold 51 is provided is a fusion cutting blade that runs along the contour line of the emblem. The fusion cutting blade 53 is employed to cut the material by fusion cutting. While no pressing blade for forming an undulated pattern is shown In the instance of the illustrated embodiment, it is possible to provide the carving metal mold with a pressing blade.

As shown in FIG. 4, the top surface 43 of the table 41 is flat. Steps (a) through (3) of the manufacturing method according to the present invention are executed by using the table 41 and the carving metal mold 51.

The apparatus to be used for steps (d) through (f) include the following. Firstly, a computer (not shown) is connected to a laser carving machine (not shown). The data of the information part is prepared by means of the computer and input to the laser carving machine. More specifically, in the instance of the illustrated embodiment, “the data of the information part” refers to the second pattern part 17 and the third pattern part 19. The information part contains individual information (identification information) of the person who possesses the jacket of the like to which the emblem is attached. The data to be used to engrave a part of the upper layer so as to make it show a profile that corresponds to the individual information by means of the laser engraving machine are input to the laser engraving machine.

Any known laser engraving machine can be used for step (f) of the manufacturing method according to the present invention. Examples of such laser engraving machines include “Speedy 300 Laser Engraver and Cutter” available from Trotec. This machine allows to remove (by engraving) only the part of the upper layer material that corresponds to “the information part” by utilizing a personal computer, although the present invention is by no means limited to the use of such a machine.

A jig is employed in step (d). This is to accurately remove only the part to be removed by laser engraving.

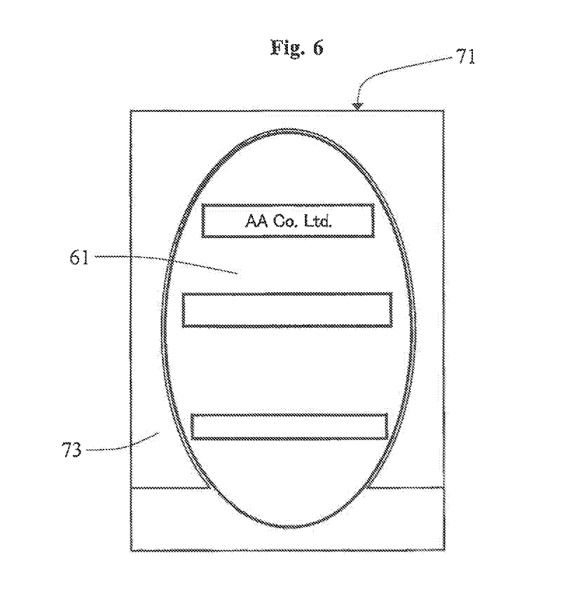

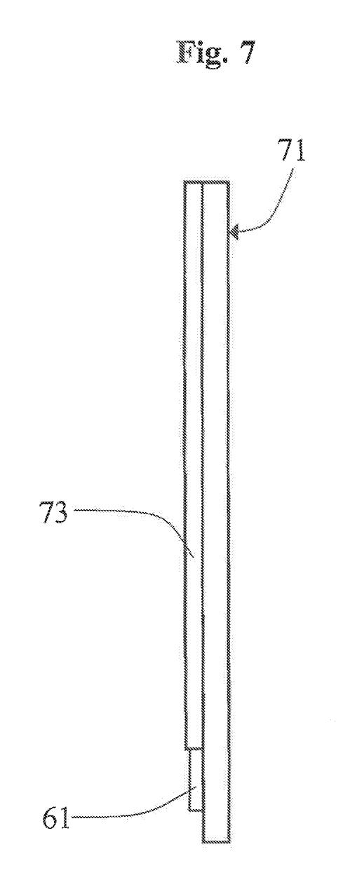

Any known jig that can be used to rigidly secure the intermediate decorative piece in position can be used as “jig” for the purpose of the present invention. For example, the jig 71 may be one having an inlay plate frame 73 that corresponds to the shape of the intermediate decorative piece 61 as shown in FIGS. 6 and 7, although the present invention is by no means limited to the use of such a jig.

<Manufacturing Method of the Present Invention>

Emblems are manufactured by utilizing apparatus as described above.

Firstly, (a) the lower layer material 31a is laid on the table 41 that operates as one of a pair of electrode for high frequency induction heating, the intermediate layer material 21a of thermoplastic synthetic resin film is laid on the lower layer material 31a and then the upper layer material 11a of thermoplastic synthetic resin film is laid on the intermediate layer material 21a.

The top surface of the upper layer material 11a is tinted in advance to the first color (e.g., golden color) by printing.

The intermediate layer material 21a may be a colored sheet of film. Alternatively, the top surface of the intermediate layer material 21a, which may be in the form of a sheet of transparent film, may be tinted in advance to the second color (e.g., black color) by printing.

(b) The upper layer material 11a, the intermediate layer material 21a and the lower layer material 31a are heated by high frequency induction heating, using an engraving metal mold 51 and a table 41 to produce a three-dimensional pattern on the upper layer material 11a and, at the same time, cut the materials by fusion cutting, using a fusion cutting blade 53. Additionally, the upper layer material and the intermediate layer material are bonded to each other by fusion bonding. If the lower layer material is a material that can be bonded b fusion bonding, the lower layer material and the intermediate layer material are also bonded to each other by fusion bonding at this time. If necessary, the upper layer material is made to show an undulated pattern by means of a pressing blade. Forming a three-dimensional pattern by high frequency induction heating and fusion cutting of the materials can be realized by using a known technique so that they will not be described any further here.

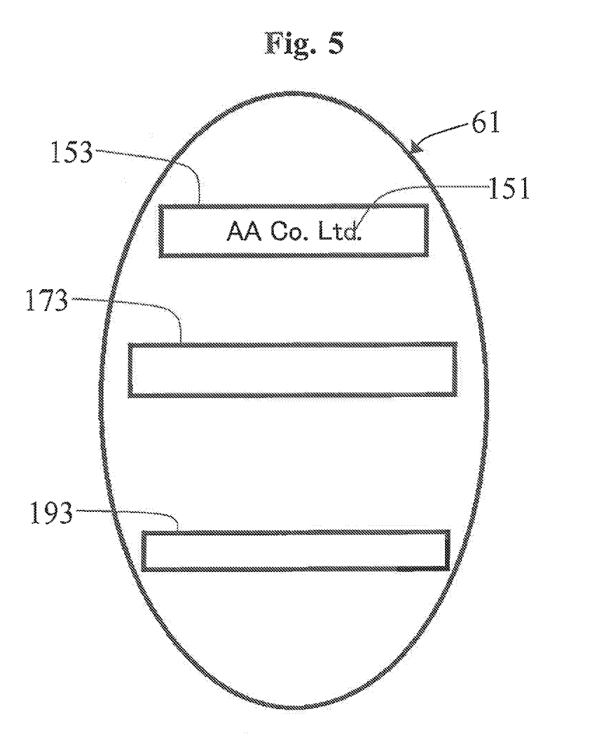

(c) All the unnecessary parts are removed to obtain an intermediate decorative piece 61 (FIG. 5).

While the rectangle 173 of the second pattern part 17 and the rectangle 193 of the third pattern part 19 are also formed in step (b) in the instance of the illustrated embodiment, the present invention is by no means limited thereto and they may alternatively be formed in one of steps (d) through (f).

In step (d), the intermediate decorative piece 61 is inlayed in the jig (FIGS. 6 and 7) and the jig is set in position in a laser engraving machine.

In step (e), the data of the individual information are prepared by the computer connected to the laser engraving machine.

In the instance of the illustrated embodiment, the data are to be used to remove parts of the upper layer material 11a so as to make it show a profile that corresponds to the characters 171 of the second pattern part 17 and the characters 191 of the third pattern part 19.

In step (f), only part of the upper layer material 11a is removed by laser engraving on the basis of the data of the individual information input to the laser engraving machine in step (e).

As shown in FIG. 2, the part of the upper layer material 11a that corresponds to the data on the individual information is removed by laser engraving. As a result, while the first color (e.g., golden color) appears on the entire emblem when the emblem is viewed from the front side, the color of the top surface 23 of the intermediate layer 21 (e.g., black color) appears on the individual information part. Then, intermediate decorative pieces can be manufactured on a mass production basis by way of steps (a) through (d) and then emblems showing individual data for identifying individuals (data showing the organizational sections to which respective individuals belong that are shown in the second pattern parts 17 and data showing ID numbers assigned to individuals that are shown in the third pattern parts 19 in the instance of the illustrated embodiment).

What is claimed is:

1. A method for manufacturing an emblem made of thermoplastic synthetic resin and having data on information of an individual bearer of the emblem, the method being characterized by comprising:
(a) placing a lower layer material on a table operating as one of a pair of electrodes for high frequency induction heating, placing an intermediate layer material of a sheet of thermoplastic synthetic resin film on the lower layer material and placing an upper layer material of thermoplastic synthetic resin film on the intermediate layer material;
(b) pressing the upper layer material, the intermediate layer material and the lower layer material by means of a carving metal mold operating as the other electrode for high frequency induction heating, the carving metal mold having a fusion cutting blade running along the contour line of the emblem and transmitting a high frequency wave to execute an induction heating operation to carve a pattern on the upper layer material;
(c) preparing an intermediate decorative piece by removing unnecessary parts;
(d) inlaying the intermediate decorative piece in a jig and setting the jig in position in a laser carving machine;
(e) preparing data on information of the individual bearer of the emblem by means of a computer connected to the laser carving machine; and
(f) executing a laser carving operation by means of the data on information of the individual bearer of the emblem, removing the upper layer material of the information part so as to expose the top surface of the intermediate layer material.

2. The method according to claim 1, characterized in that the intermediate layer material is either sheet of white thermoplastic synthetic resin film that can be colored by screen printing or a sheet of transparent thermoplastic synthetic resin film that can be colored by screen printing.

3. The method according to claim 1 characterized in that the thermoplastic synthetic resin film of the upper layer material has a vapor deposited metal layer.

4. The method according to claim 1, characterized in that the intermediate layer material is a sheet of transparent film and the lower layer material is a translucent material.

5. The method according to claim 1, characterized in that the lower layer material is thermoplastic synthetic resin film, fabric, hot melt film or double sided tape made of thermoplastic synthetic resin film.

6. The method according to claim 1, characterized in that the thermoplastic synthetic resin film of the upper layer material, the intermediate layer material or the lower layer material is soft and flexible.
